(19) United States
(12) Patent Application Publication
(10) Pub. No.: US 2008/0063414 A1
(43) Pub. Date: Mar. 13, 2008

(54) IMAGE FORMING APPARATUS AND METHOD OF DETERMINING STATE OF SHEET HANDLING APPARATUS DISCONNECTABLY CONNECTED THERETO

(75) Inventors: Eiichi Motoyama, Tokyo (JP); Yasuhiro Yako, Tokyo (JP); Kuniyasu Kimura, Toride-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/851,358

(22) Filed: Sep. 6, 2007

(30) Foreign Application Priority Data
Sep. 8, 2006 (JP) 2006-244709

(51) Int. Cl. G03G 21/00

(52) U.S. Cl. 399/18; 399/21

(57) ABSTRACT

An image forming apparatus which is capable of judging whether or not a sheet handling apparatus is connected or faulty without provision of a sheet handling apparatus mechanical connection-detecting section, and reducing the size and manufacturing costs of the apparatus. To an image forming apparatus, a sheet handling apparatus is disconnectably connected. A communicating portion communicates with the sheet handling apparatus. A control sections judges whether or not the image forming apparatus or the sheet handling apparatus is abnormal. The control section provides a display for confirming disconnection of the sheet handling apparatus, if it is judged that the image forming apparatus or the sheet handling apparatus is not abnormal, when the communication with the sheet handling apparatus by the communicating portion is impossible.

### BACKGROUND OF THE INVENTION

1. Field of the Invention

The present invention relates to an image forming apparatus to which a sheet handling apparatus is disconnectably connected, and a method of determining a state of the sheet handling apparatus.

2. Description of the Related Art

FIG. 8 is a schematic diagram of a conventional image forming system.

In FIG. 3, the image forming system is comprised of an image forming apparatus 100, and a discharge sheet processing apparatus (sheet handling apparatus) 100 disposed at a sheet discharging part of the image forming apparatus 100.

The image forming apparatus 100 is comprised of an image forming apparatus control section 101 that controls the whole image forming system, an operating display section 102 that displays a state concerning the whole image forming system and is used for giving instructions, and a sheet conveying passage 103 that conveys sheets toward the discharge sheet processing apparatus 110.

The discharge sheet processing apparatus 110 aligns a plurality of sheets on which images are formed, and performs finishing processes, such as stapling, punching, and bending.

The discharge sheet processing apparatus 110 includes a discharge sheet processing apparatus control section 111 that controls the discharge sheet processing apparatus 110, and a stapler 112 that performs stapling as a finishing process.

Further, the image forming system includes a communication line 120 that performs communication between the image forming apparatus control section 101 and the discharge sheet processing apparatus control section 111, and a discharge sheet processing apparatus connection-detecting section 130 that detects whether or not the image forming apparatus 100 and the discharge sheet processing apparatus 110 are connected.

The image forming apparatus control section 101 gives instructions as to an operation mode, such as stapling, to the discharge sheet processing apparatus control section 111, via the communication line 120, and performs sequence processing e.g. concerning timing for passing sheets.

Further, based on a detection signal from the discharge sheet processing apparatus connection-detecting section 130, the image forming apparatus control section 101 determines whether or not the discharge processing apparatus 110 is connected and the discharge processing apparatus control section 111 determines whether or not the image forming apparatus 100 is connected. The discharge sheet processing apparatus connection-detecting device 130 is formed e.g. by a drawer connector, and uses a signal line which is electrically connected by mounting of the discharge sheet processing apparatus 110.

Under such arrangement, it is sometimes required to temporarily disconnect the discharge sheet processing apparatus 110 from the image forming apparatus 100 so as to remove jammed sheets (for sheet jam handling). In such a case, thanks to the discharge sheet processing apparatus connection-detecting section 130, it is possible to detect that the discharge sheet processing apparatus 110 is mechanically disconnected.

Further, even in a state where the discharge sheet processing apparatus control section 111 and the image forming apparatus control section 101 are mechanically disconnected from each other, the discharge sheet processing apparatus control section 111 and the image forming apparatus control section 101 are electrically connected by a communication line (cable) 120. Therefore, even in this case, the image forming apparatus control section 101 is capable of continuing communication with the discharge sheet processing apparatus control section 111.

FIG. 9 is a flowchart showing a process for coping with a communication incapability, which is executed by the image forming system shown in FIG. 8.

The process shown in FIG. 9 is an example of the process executed when communication between the image forming apparatus control section 101 and the discharge sheet processing apparatus control section 111 ceases to be normally carried out, in the case where the image forming system is provided with the discharge sheet processing apparatus connection-detecting section 130.

In FIG. 9, first, the image forming apparatus control section 101 confirms using the discharge sheet processing apparatus connection-detecting section 130 whether or not the discharge sheet processing apparatus 110 is connected (step S101). If the discharge sheet processing apparatus 110 is not connected, the present process is immediately terminated.

If the discharge sheet processing apparatus 110 is connected, the image forming apparatus control section 101 displays a message notifying failure of the discharge sheet processing apparatus 110 on the operating display section 102 (step S102), and stops the operation of the image forming system (step S103), followed by terminating the present process.

FIG. 10 is a flowchart showing a process for coping with a communication incapability, which is executed by the image forming system in the case where the image forming system is not provided with the discharge sheet processing apparatus connection-detecting section 130.

In the case of an image forming system incapable of disconnecting the discharge sheet processing apparatus 110 and the case of an image forming system for which an operator sets, using a switch or the like, as to whether the discharge sheet processing apparatus is connected, the discharge sheet processing apparatus connection-detecting section 130 becomes unnecessary.

In FIG. 10, if the image forming apparatus control section 101 is incapable of communicating with the discharge sheet processing apparatus 111, it judges that the discharge sheet processing apparatus 111 is faulty, and displays a message notifying failure thereof on the operating display section 102 (step S201), and stops the operation of the image forming system (step S202), followed by terminating the present process.

It should be noted that techniques concerning communication between the image forming apparatus and the discharge sheet processing apparatus are disclosed in Japanese Laid-Open Patent Publications (Kokai) No. 2000-211805 and No. 2001-134031.

Now, to reduce the size and manufacturing costs of the image forming system, it is envisaged to eliminate a cable for communication between the discharge sheet processing apparatus control section and the image forming apparatus control section, and use a drawer connection or wireless communication using electromagnetic waves.

However, if no cable is provided for communication between the discharge sheet processing apparatus control section and the image forming apparatus control section, if the discharge sheet processing apparatus is temporarily disconnected or removed for maintenance, such as sheet jam handling, it is impossible to perform communication during all the while. In this case, it is impossible to determine where the communication incapable state is due to failure or for maintenance, unless a discharge sheet processing apparatus connection-detecting section for use in detecting a mechanical connection between the discharge sheet processing apparatus and the image forming apparatus detects disconnection or removal of the discharge sheet processing apparatus.

### SUMMARY OF THE INVENTION

The present invention provides an image forming apparatus which is capable of judging whether or not a sheet handling apparatus is connected or faulty (judging a state of the sheet handling apparatus) without provision of a sheet handling apparatus mechanical connection-detecting section, and reducing the size and manufacturing costs of the apparatus, and a method of judging a state of the sheet handling apparatus disconnectably connected to the image forming apparatus.

In a first aspect of the present invention, there is provided an image forming apparatus to which a sheet handling apparatus is disconnectably connected, comprising a communicating portion configured to perform communication with the sheet handling apparatus, a judgment portion configured to judge whether or not the image forming apparatus or the sheet handling apparatus is in an abnormal state, and a control portion configured to provide a display for confirming disconnection of the sheet handling apparatus, if the judgment portion has judged that the image forming apparatus or the sheet handling apparatus is not in the abnormal state, when the communication with the sheet handling apparatus by the communicating portion is impossible.

With the arrangement of the image forming apparatus according to the first aspect of the present invention, the image forming apparatus includes a judgment portion that judges as to whether o the image forming apparatus or the sheet handling apparatus is in an abnormal state, when the communication with the sheet handling apparatus is impossible. Further, the image forming apparatus includes a control portion that provides a display for confirming disconnection of the sheet handling apparatus, if the judgment portion has judged that the image forming apparatus or the sheet handling apparatus is not in the abnormal state. This enables the user to judge a state of the sheet handling apparatus in response to the display for confirmation of the disconnection. Therefore, without provision of a sheet handling apparatus mechanical connection-detecting section, it is possible to judge whether the sheet handling apparatus is connected or faulty, and reduce the size and manufacturing costs of the image forming apparatus.

The control portion can be configured to provide a display requesting an input as to whether or not the sheet handling apparatus has been disconnected.

The image forming apparatus comprises an input portion configured to input whether or not the sheet handling apparatus has been disconnected, and when the input portion inputs that the sheet handling apparatus has not been disconnected, the control portion provides a display concerning failure of the communicating portion.

When the input portion inputs that the sheet handling apparatus has been disconnected, the control portion provides a display concerning an operation mode in which the sheet handling apparatus is not connected.

The abnormal state includes a sheet-jammed state of the image forming apparatus or the sheet handling apparatus.

The abnormal state includes a state of the image forming apparatus in which toner has run out.

In a second aspect of the present invention, there is provided an image forming apparatus to which a sheet handling apparatus is disconnectably connected, comprising a communicating portion configured to perform communication with the sheet handling apparatus, a control portion configured to provide a display requesting an input as to whether or not the sheet handling apparatus has been disconnected, when the communication with the sheet handling apparatus by said communicating portion is impossible, and an input portion configured to input whether or not the sheet handling apparatus has been disconnected, and when the input portion inputs that the sheet handling apparatus has not been disconnected, the control portion provides a display concerning failure of the communicating portion.

In a third aspect of the present invention, there is provided a control method for an image forming apparatus to which a sheet handling apparatus is disconnectably connected, and which performs communication with the sheet handling apparatus, comprising the steps of detecting an incapability of communication with the sheet handling apparatus, judging whether or not the image forming apparatus or the sheet handling apparatus is in an abnormal state, and providing a display for confirming disconnection of the sheet handling apparatus, if incapability of communication with the sheet handling apparatus has been detected in the detecting step and it is judged in the judgment step that the image forming apparatus or the sheet handling apparatus is not in the abnormal state.

In a fourth aspect of the present invention, there is provided a control method for an image forming apparatus to which a sheet handling apparatus is disconnectably connected, and which performs communication with the sheet handling apparatus, comprising the steps of detecting incapability of communication with the sheet handling apparatus, providing a display requesting an input as to whether or not the sheet handling apparatus has been disconnected, if the incapability of communication with the sheet handling apparatus has been detected in the detecting step, and providing a display concerning failure of the communicating portion if in response to the display step, there is provided an input that the sheet handling apparatus has not been disconnected.

In a fifth aspect of the present invention, there is provided an image forming apparatus to which a sheet handling apparatus is disconnectably connected, comprising a communicating portion configured to perform communication with the sheet handling apparatus, a judgment portion configured to judge whether or not the image forming apparatus or the sheet handling apparatus is in an abnormal state, and a control portion configured not to judge that the communicating portion is broken, if the judgment portion has judged that the image forming apparatus or the sheet handling apparatus is in the abnormal state, when the communication with the sheet handling apparatus by the communicating portion is impossible.

The above and other objects, features, and advantages of the invention will become more apparent from the following detailed description taken in conjunction with the accompanying drawings.

### BRIEF DESCRIPTION OF THE DRAWINGS

FIG. 1 is a diagram showing essential parts of an image forming system including an image forming apparatus according to an embodiment of the present invention.

FIG. 2 is a flowchart showing a process for determining a state of a discharge sheet processing apparatus, which is executed by the image forming apparatus appearing in FIG. 1.

FIG. 3 is a diagram of a first example of display on an operating display section appearing in FIG. 1.

FIG. 4 is a diagram of a second example of display on the operating display section.

FIG. 5 is a diagram of a third example of display on the operating display section.

FIG. 6 is a flowchart showing a communication start/resume process which is executed by the image forming system.

FIG. 7 is a flowchart showing an initializing process which is executed by the image forming system.

FIG. 8 is a diagram of a conventional image forming system.

FIG. 9 is a flowchart showing a process for coping with a communication incapability, which is executed by the image forming system shown in FIG. 8.

FIG. 10 is a flowchart showing a process for coping with a communication incapability, which is executed by the image forming system, when a discharge processing apparatus connection-detecting section appearing in FIG. 8 is not provided.

### DETAILED DESCRIPTION OF THE PREFERRED EMBODIMENTS

The present invention will now be described in detail below with reference to the drawings showing a preferred embodiment thereof.

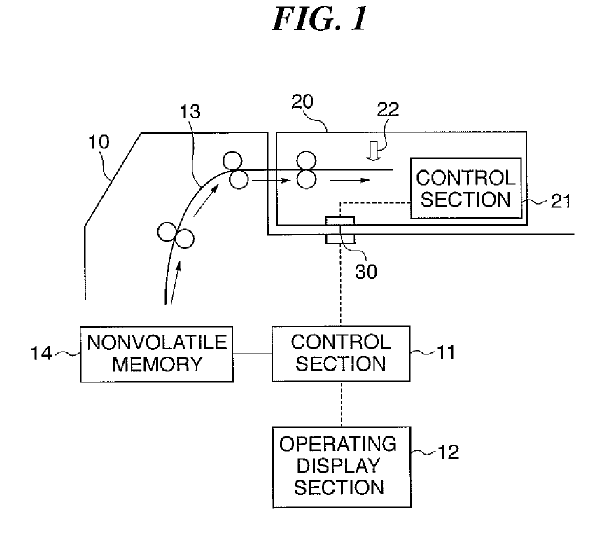

FIG. 1 is a schematic diagram of an image forming system including an image forming apparatus according to the embodiment of the present invention.

As shown in FIG. 1, the image forming system is comprised of an image forming apparatus 10, and a discharge sheet processing apparatus (sheet handling apparatus) 20 disposed at a discharge sheet part of the image forming apparatus 10.

The image forming apparatus 10 is comprised of an image forming apparatus control section 11 that controls the whole image forming system, an operating display section 12 that displays a state of the whole image forming system and is used for giving instructions, a sheet conveying passage 13 that conveys sheets toward the discharge sheet processing apparatus 20, and a nonvolatile memory 14.

The discharge sheet processing apparatus 20 aligns a plurality of sheets on which images are formed, and performs finishing processes, such as stapling, punching, and bending.

The discharge sheet processing apparatus 20 includes a discharge sheet processing apparatus control section 21 that controls the discharge sheet processing apparatus 20, and a stapler 22 that performs stapling as a finishing process.

Further, the image forming system includes a communicating portion 30 that performs communication between the image forming apparatus control section 11 and the discharge sheet processing apparatus control section 21. The communicating portion 30 does not have a cable for communication between the image forming apparatus 10 and the discharge sheet processing apparatus 20, and if the discharge sheet processing apparatus 20 is disconnected i.e. detached from the image forming apparatus 10, the connection by the communicating portion 30 is cancelled to disable the communication.

The image forming apparatus control section 11 gives instructions as to an operation mode, such as stapling, to the discharge sheet processing apparatus control section 21, via the communicating portion 30, and performs sequence processing concerning e.g. timing for passing sheets.

Further, the discharge sheet processing apparatus 20 is disconnectable from the image forming apparatus 10, and the image forming apparatus 10 is capable of operation irrespective of whether the discharge sheet processing apparatus 20 is connected thereto. Possible situations in which the image forming apparatus 10 is used in a state in which the discharge sheet processing apparatus 20 is disconnected therefrom include a case where the discharge sheet processing apparatus 20 is disconnected, i.e. detached so to be connected to another image forming apparatus for use therewith, and a case where the image forming apparatus is subjected to maintenance, e.g. for removing jammed sheets therefrom.

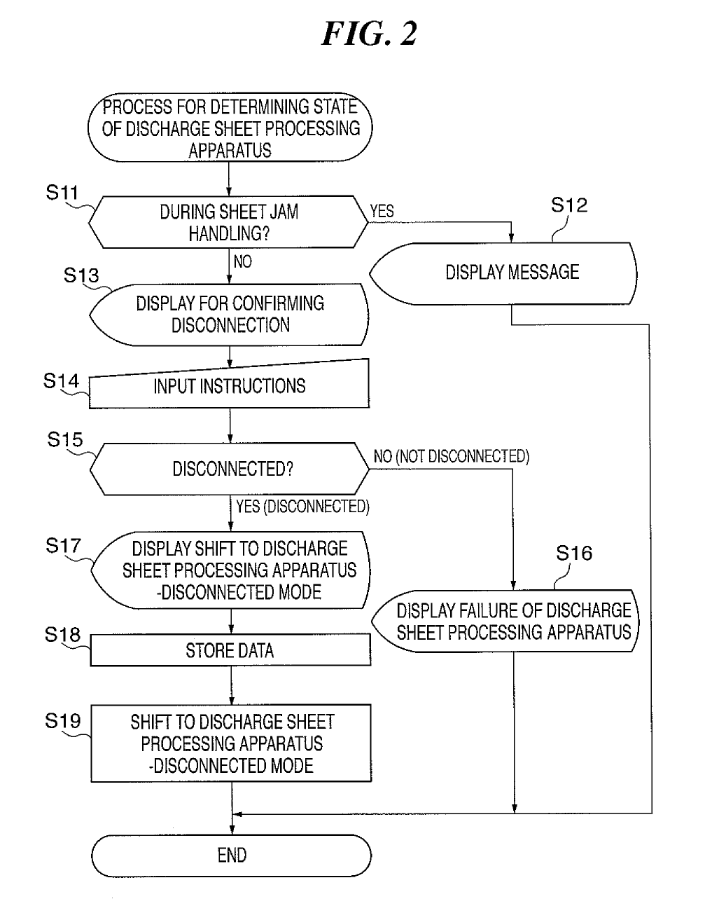

FIG. 2 is a flowchart showing a process for determining a state of the discharge sheet processing apparatus, which is executed by the image forming system shown in FIG. 1.

This process is executed by the image forming apparatus control section 11 appearing in FIG. 1.

Referring to FIG. 1, when detecting a communication incapable state, the control section 11 judges a state of the image forming apparatus, e.g. whether or not sheet jam handling is being carried out for removing jammed sheets, which requires disconnection of the discharge sheet processing apparatus 20 from the image forming apparatus system 10. The reason for carrying out the judgment is that the communication becomes impossible in two cases: a case where the discharge sheet processing apparatus 20 is disconnected, and a case where the same is faulty. The sheet jam handling is specifically a process carried out for removing sheets jammed in the sheet conveying passage 13 (including an exit thereof) of the image forming apparatus 10, sheets jammed at an entrance or its vicinity of the discharge sheet processing apparatus 20, or the like.

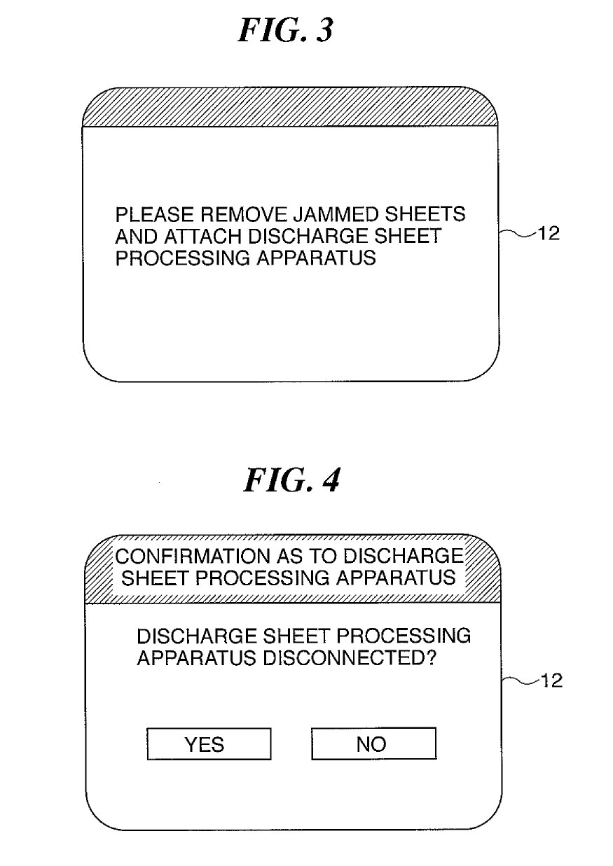

If the sheet jam handling is being carried out, there is a high possibility that the communicating portion is not faulty but the user has disconnected the discharge sheet processing apparatus 20 for the purpose of sheet jam handling. Therefore, the control section 11 judges that the communication is disabled due to temporary disconnection of the discharge sheet processing apparatus 20 for sheet jam handling, and displays a message to this effect on the operating display section 12 (step S12), followed by terminating the present process. In other words, the control section 11 does not judge that the communicating portion 30 is faulty. The message displayed on the operating display section 12 is, for example, one illustrated in FIG. 3 which says “Please remove jammed sheets and attach discharge sheet processing apparatus”.

If the sheet jam handling is not being carried out, the control section 11 is incapable of judging whether the discharge sheet processing apparatus 20 has intentionally been disconnected by the user or is faulty, and hence it displays a message on the operating display section 12, for confirming whether or not the user has intentionally disconnected the discharge sheet processing apparatus 20 (step S13), and waits for the user to perform an operation in response thereto (step S14).

An example of the message displayed in the step S13 is shown in FIG. 4. Details of the message depend on the performance of the operating display section 12, and are not necessarily limited to the illustrated example. Depending on the case, a host computer may be used as an operating display section for displaying the message.

If “No” is input in the displayed screen shown in FIG. 4 (NO to the step S15), i.e. if the user has not disconnected the discharge sheet processing apparatus 20, it is considered that a communication trouble has occurred in the discharge sheet processing apparatus 20, and hence the control section 11 displays a message to this effect on the operating display section 2 (step S16), followed by terminating the present process.

If “Yes” is input in the displayed screen in FIG. 4 (YES to the step S15), the control section 11 displays a message to the effect that the image forming system shifts to a discharge sheet processing apparatus-disconnected mode on the operating display section 12 (step S17).

Then, the control section 11 stores data indicative of the discharge sheet processing apparatus-disconnected mode in the nonvolatile memory 14 (step S18) and causes the system to shift to the discharge sheet processing apparatus-disconnected mode (step S19), followed by terminating the present process.

Although in the illustrated process for judging a state of the discharge sheet processing apparatus, in the step S11, it is judged, by way of example, whether or not the sheet jam handling is being carried out, a judgment as to whether the discharge sheet processing apparatus 20 is temporarily disconnected due to some other cause than sheet jam or like other judgments may be additionally executed before the disconnection confirming display is carried out in the step S13.

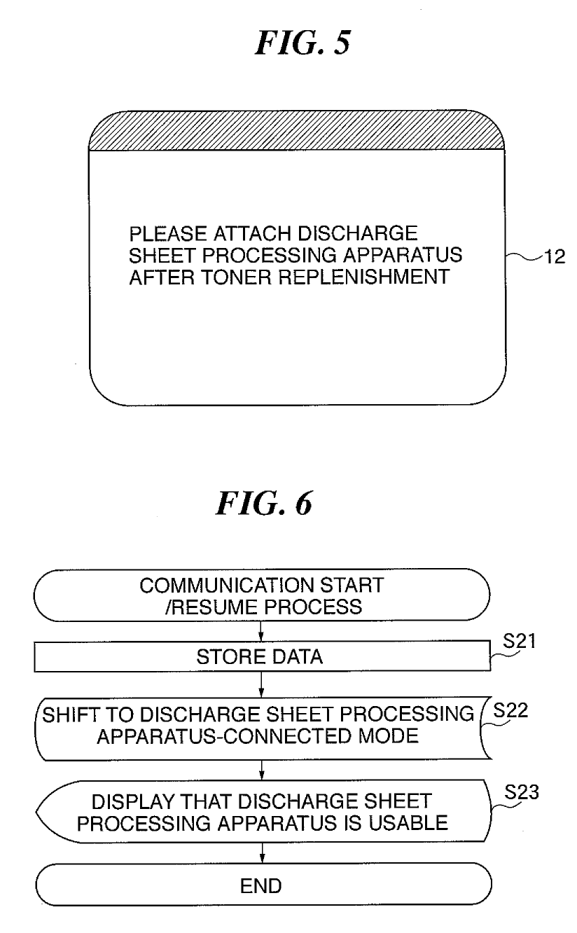

For example, if it is necessary to temporarily disconnect the discharge sheet processing apparatus 20 for toner replenishment due to depletion of toner, a message as shown in FIG. 5 is displayed, followed by terminating the present process.

Thus, in response to one phenomenon of the incapability of communication with the discharge sheet processing apparatus, it is possible to perform appropriate judgment in a manner dependent on the situation. Further, in the illustrated example of the process, it is assumed at the start thereof that the state of the discharge sheet processing apparatus 20 stored in the nonvolatile memory 14 is a discharge sheet processing apparatus-connected mode, it is to be understood that judgment concerning the state of the discharge sheet processing apparatus 20 may executed as deemed appropriate.

FIG. 6 is a flowchart showing a communication start/resume process executed by the image forming system.

This process is executed by the image forming apparatus control section 11 when it becomes possible to perform communication with the discharge sheet processing apparatus control section 21, which has been disabled hitherto.

Referring to FIG. 6, the control section 11 stores data indicative of the discharge sheet processing apparatus-connected mode in the nonvolatile memory 14 (step S21), and then causes the system to shift to the discharge sheet processing apparatus-connected mode (step S22). Then, the control section 11 displays a message notifying the fact the discharge sheet processing apparatus 20 becomes usable, on the operating display section 12 (step S23).

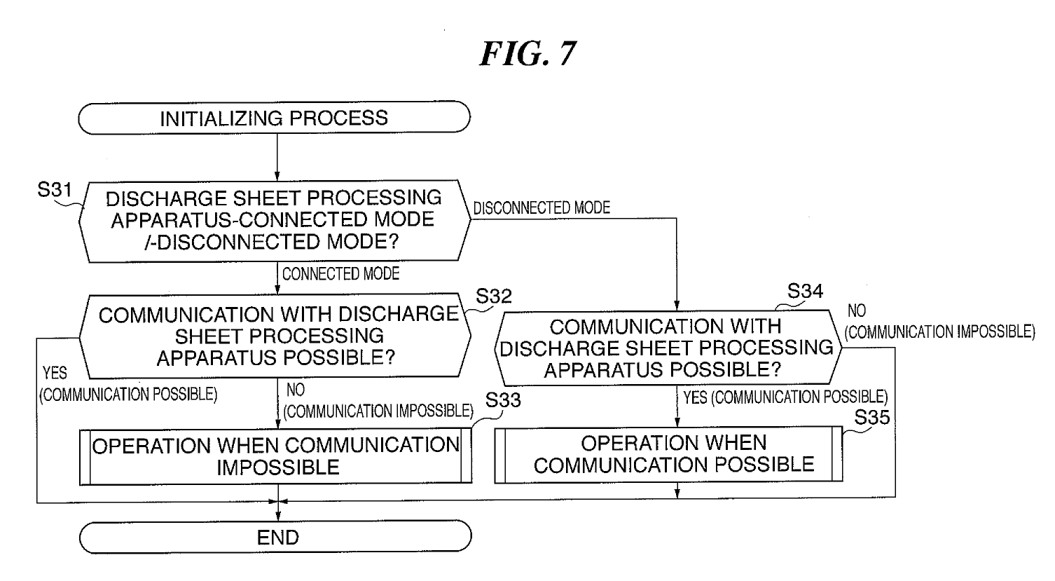

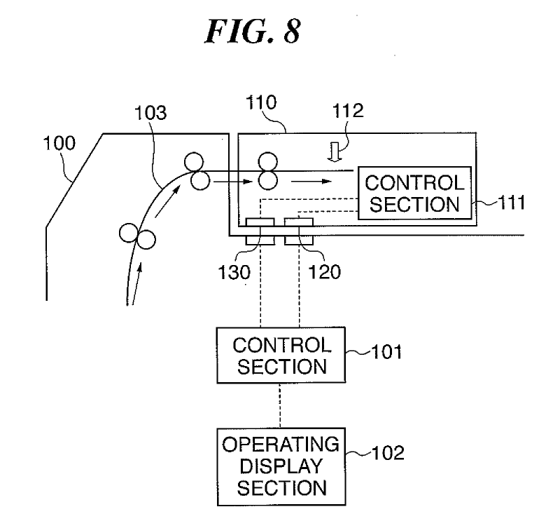

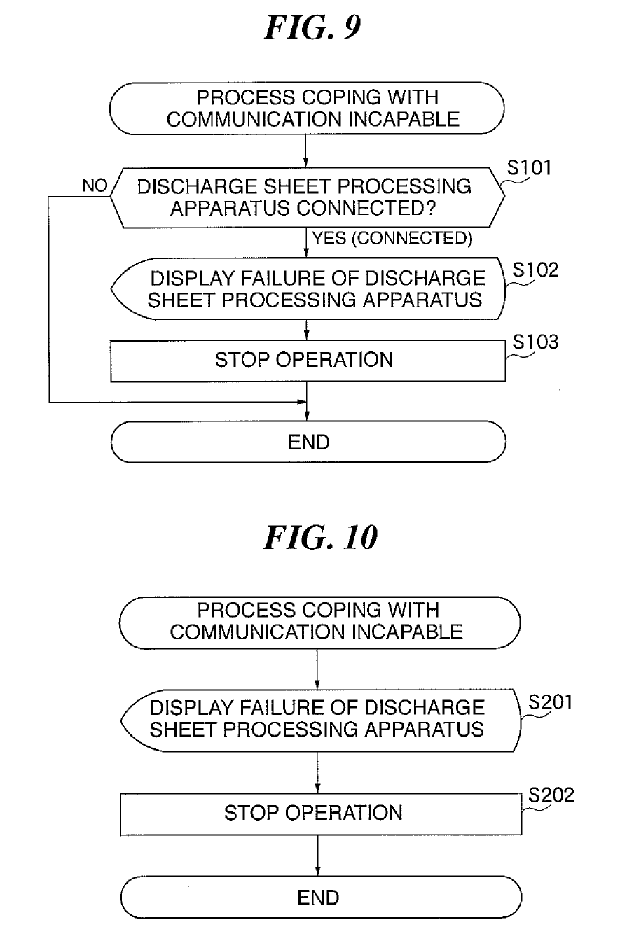

FIG. 7 is a flowchart showing an initializing process executed by the image forming system.

This process is carried out when the image forming apparatus control section 11 is initialized, e.g. upon turn-on of the power.

In FIG. 7, first, the control section 11 determines based on the data stored in the nonvolatile memory 14 whether or not the system is in the discharge sheet processing apparatus-connected mode or the discharge sheet processing apparatus-disconnected mode (step S31), and if the system is in the discharge sheet processing apparatus-connected mode, the process proceeds to a step S32, whereas if the system is in the discharge sheet processing apparatus-disconnected mode, the process proceeds to a step S34.

In the step S32, it is determined whether or not communication with the discharge sheet processing apparatus 20 is possible. If possible (YES to the step S32), the system continues to operate in the discharge sheet processing apparatus-connected mode, followed by terminating the present process.

If the communication with the discharge sheet processing apparatus 20 is not possible (NO to S32), the process shown in FIG. 2 for the case of the communication being impossible is executed, whereby the system starts to operate in the discharge sheet processing apparatus-disconnected mode (step S33).

In the step S34, the control section 11 determines whether or not the communication with the discharge sheet processing apparatus 20 is possible. If the communication with the discharge sheet processing apparatus 20 is possible, the process shown in FIG. 6 for starting or resuming the communication is executed, whereby the system starts to operate in the discharge sheet processing apparatus-connected mode (step S35). If the communication is impossible, the process is immediately terminated without further processing, since this step is executed, originally assuming that the image forming apparatus is in the discharge sheet processing apparatus-disconnected mode.

Although in the above-described embodiment, the discharge sheet processing apparatus is described as an example of the sheet handling apparatus, but the sheet handling apparatus may be a sheet feeding device.

While the present invention has been described with reference to exemplary embodiments, it is to be understood that the invention is not limited to the disclosed the embodiments. The scope of the following claims is to be accorded the broadest interpretation so as to encompass all such modifications and equivalent structures and functions.

This application claims the benefit of Japanese Patent Application No. 2006-244709, filed Sep. 8, 2006 which is hereby incorporated by reference herein in its entirety.

What is claimed is:

1. An image forming apparatus to which a sheet handling apparatus is disconnectably connected, comprising:
a communicating portion configured to perform communication with the sheet handling apparatus;
a judgment portion configured to judge whether or not the image forming apparatus or the sheet handling apparatus is in an abnormal state; and
a control portion configured to provide a display for confirming disconnection of the sheet handling apparatus, if said judgment portion has judged that the image forming apparatus or the sheet handling apparatus is not in the abnormal state, when the communication with the sheet handling apparatus by said communicating portion is impossible.

2. An image forming apparatus as claimed in claim 1, where said control portion is configured to provide a display requesting an input as to whether or not the sheet handling apparatus has been disconnected.

3. An image forming apparatus as claimed in claim 2, comprising an input portion configured to input whether or not the sheet handling apparatus has been disconnected, and
wherein when said input portion inputs that the sheet handling apparatus has not been disconnected, said control portion provides a display concerning failure of said communicating portion.

4. An image forming apparatus as claimed in claim 2, wherein when said input portion inputs that the sheet handling apparatus has been disconnected, said control portion provides a display concerning an operation mode in which the sheet handling apparatus is not connected.

5. An image forming apparatus as claimed in claim 1, wherein the abnormal state includes a sheet-jammed state of the image forming apparatus or the sheet handling apparatus.

6. An image forming apparatus as claimed in claim 1, wherein the abnormal state includes a state of the image forming apparatus in which toner has run out.

7. An image forming apparatus to which a sheet handling apparatus is disconnectably connected, comprising:
a communicating portion configured to perform communication with the sheet handling apparatus;
a control portion configured to provide a display requesting an input as to whether or not the sheet handling apparatus has been disconnected, when the communication with the sheet handling apparatus by said communicating portion is impossible; and
an input portion configured to input whether or not the sheet handling apparatus has been disconnected,
wherein when said input portion inputs that the sheet handling apparatus has not been disconnected, said control portion provides a display concerning failure of said communicating portion.

8. A control method for an image forming apparatus to which a sheet handling apparatus is disconnectably connected, and which performs communication with the sheet handling apparatus, comprising the steps of:
detecting an incapability of communication with the sheet handling apparatus;
judging whether or not the image forming apparatus or the sheet handling apparatus is in an abnormal state; and
providing a display for confirming disconnection of the sheet handling apparatus, if incapability of communication with the sheet handling apparatus has been detected in said detecting step and it is judged in said judgment step that the image forming apparatus or the sheet handling apparatus is not in the abnormal state

9. A control method for an image forming apparatus to which a sheet handling apparatus is disconnectably connected, and which performs communication with the sheet handling apparatus, comprising the steps of:
detecting incapability of communication with the sheet handling apparatus;
providing a display requesting an input as to whether or not the sheet handling apparatus has been disconnected, if the incapability of communication with the sheet handling apparatus has been detected in said detecting step; and
providing a display concerning failure of said communicating portion if in response to said display step, there is provided an input that the sheet handling apparatus has not been disconnected.

10. An image forming apparatus to which a sheet handling apparatus is disconnectably connected, comprising:
a communicating portion configured to perform communication with the sheet handling apparatus;
a judgment portion configured to judge whether or not the image forming apparatus or the sheet handling apparatus is in an abnormal state; and
a control portion configured not to judge that said communicating portion is broken, if said judgment portion has judged that the image forming apparatus or the sheet handling apparatus is in the abnormal state, when the communication with the sheet handling apparatus by said communicating portion is impossible.
